(19) United States
(12) Patent Application Publication
(10) Pub. No.: US 2015/0292986 A1
(43) Pub. Date: Oct. 15, 2015

(54) DEVICE FOR SAMPLING AND WORK-UP OF A SAMPLE

(71) Applicant: FROST DIAGNOSTIKA GMBH, Oiterstadt (DE)

(72) Inventor: Gabriele Maria Frost, Speyer (DE)

(21) Appl. No.: 14/364,285

(22) PCT Filed: Dec. 23, 2013
(86) PCT No.: PCT/EP2013/077963

§ 371 Date: Jun. 10, 2014

(30) Foreign Application Priority Data
Dec. 22, 2012 (DE) 10 2012 113 072.8

(51) Int. Cl. G01N 1/02; G01N 1/38

(52) U.S. Cl. CPC G01N 1/02; G01N 1/38; G01N 2001/382

(57) ABSTRACT

Device for sampling, work-up and preliminary analysis of a sample comprising a sampling rod (18) with a sample taking structure forming a sample space (16) for taking a defined amount of a sample and a sample receiving tube (1), comprising a mixing chamber (19) filled with liquid for preserving, dissolution, workup and development of the sample contained in sample space 16, wherein the sampling rod (11) is designed as hollow body open on both sides with an ejection punch (18) movably and sealingly guided in the sampling rod (11) designed to eject the sample from sample space (16) into mixing chamber (19).

The present invention relates to a device for taking, work-up and preliminary analysis of a sample for the qualitative and quantitative determination of substances contained therein, in particular for a sample of human stool for the analysis of human stool, comprising a sampling rod (stick) with a sample taking structure forming a sample space to collect a defined amount of the sample and a sampling tube capable to take-up the sampling rod (stick), said sampling tube comprising a mixing chamber filled with a liquid for preserving, dissolution, work-up and development of the sample present in the sample space.

Human stool (feces) may comprise a substantial number of substances and pathogens, the type and percentage of which in the human stool is of importance for the recognition and treatment of many diseases. For example, toxic or radioactive substances, pathogens and inflammations (infections) or parasites taken up by the body or other substances, such as e.g. histamin which plays an important role in the defense against substances foreign to the body or in allergic reactions, may be detected through examination of human stool.

After the detection of the substances contained in the stool or living samples or cultures in a first examination step a reliable diagnostic analysis of the discomforts caused by the detected substances is only possible through a qualitative and quantitative determination of their content in the respective sample in a second examination step.

In the device described in DE 20 2009 015 624 a specified volume of a sample to be analyzed can be taken and subsequently dissolved in a liquid which is contained in the sample tube, into which the sampling rod or stick is introduced.

However, to achieve a sufficient reproduceability with the device described in this reference the sample to be analyzed needs to have a certain consistency. If the sample is to too rigid or too liquid the sampling of a pre-defined volume is very difficult.

In WO 2012/171,511 a device for taking and workup of a sample is described which comprises a sampling rod (stick) with a sample taking structure forming a sample space to collect a defined amount of the sample and a sampling tube capable of taking up the sampling rod (stick), said sampling tube comprising a mixing chamber filled with a liquid for preserving, dissolution and work-up of the sample present in the sample space, wherein the sampling rod (stick) is formed as a hollow body open on both sides with an ejection punch (piston) movably and sealingly guided within the sampling rod. At the distal end of the ejection punch or piston a small spherical ball may be attached or allocated as mixing aid.

This small ball may lead to difficulties in particular in those cases, where the opposite end to the distal end of the ejection punch or piston is formed as a dripping tip, as it may block the exit channel of the dripping tip.

It was thus an object of the present invention, to avoid the disadvantages described above for the devices of the prior art and to provide a device for the taking, work up and preliminary analysis of a sample, with which a reproducible amount of a sample can be taken and prepared for the quantitative analysis.

This object is achieved in accordance with the invention with a device as defined in claim 1.

Preferred embodiments of the invention are described in the dependent claims and in the subsequent detailed specification.

The device in accordance with the invention comprises a sampling rod, which is formed as hollow body open on both sides. Within this hollow body an ejection punch (piston) is provided, which is movable in said sampling rod and sealingly guided therein, with which the sample taken can be transferred from the sample space at the end of the sampling rod into a mixing chamber.

In the hollow space of the sampling rod in accordance with a first embodiment of the invention an element supporting the mixing process is provided, which is transferred into the mixing chamber in the course of the ejection of the sample with the ejection punch or piston. This element supporting the mixing process consists of a material with a specific density of at least 2 g/cm³, preferably of at least 2.5 g/cm³ whereby during shaking or centrifugation of the sample a rapid movement of the element supporting the mixing process in the liquid is securely achieved and thus a complete removal of the sample from the sample space in the sampling rod and a complete dissolution of the sample is ascertained.

This embodiment of the invention is particularly suitable for devices which comprise a dripping tip at the end of the device opposite to the distal end of the sampling rod or stick.

In accordance with a further embodiment of the present invention the device in accordance with the invention does not comprise a dripping tip but is formed in a conical or circular shape at the end of the mixing chamber opposite to the distal end of the ejection punch or piston. In this embodiment the element supporting the mixing process is already in the mixing chamber and not transferred into same only with the ejection of the sample. This allows to design the element supporting the mixing process with a greater diameter to enhance the supporting effects of the mixing process as there is no limitation by the inner diameter of the sampling rod or stick. The upper limit in this case is the diameter respectively the cross section of the mixing chamber.

In the embodiment of the device with the dripping tip in accordance with the invention the dimensioning of the element supporting the mixing process is subject to limitations due to the necessity that the device in the area of the mixing chamber has to be squeezable to produce the desired droplets, which is difficult or impossible if the diameter or cross section of the element supporting the mixing process present in the mixing chamber is nearly the same as the diameter or cross section of the mixing chamber.

For these reasons the element supporting the mixing process in the device according to the invention with a dripping tip normally has a diameter or cross section significantly smaller than the diameter or cross section of the mixing chamber and which is preferably at least 20%, particularly preferably at least 50% smaller than the diameter or cross section of the mixing chamber.

The shape of the element supporting the mixing process inside the sampling rod or stick or of the element supporting the mixing process present in the mixing chamber is not subject to any principal limitations.

For the embodiment in which the element is located in the sampling rod or stick it has to be assured that in the course of transferring the sample into the mixing chamber with the ejection punch or piston the element supporting the mixing process is also transferred into the mixing chamber.

In some cases it has proved to be advantageous if the element supporting the mixing process does not have a spherical or ball shape. Ball-shaped or spherical elements, in particular in those cases where the device in accordance with the invention comprises a dripping tip at the end of the device opposite to the distal end of the ejection punch or piston (in accordance with a first embodiment of the invention), may give rise to problems if said elements settle in the dripping tip and thus make it difficult to take an amount of sample with the dripping tip. This may require additional elements to avoid such a blocking.

Just by way of example, lamellar shapes, rods or spiral elements for supporting the mixing process may be mentioned as suitable shapes for the elements supporting the mixing process transferred into the mixing chamber in the course of the ejection process or present in the mixing chamber which have proved to be advantageous in some cases. The diameter or thickness thereof preferably should exceed the diameter of the dripping tip in cases where the device in accordance with the invention comprises such dripping tip.

Particularly preferable are spiraled elements or elements formed following a spiral as the adhesion of the samples is usually low for such forms and the risk of a blocking of a dripping tip eventually present is also reduced.

Through the use of a material with a high specific density the mixing supporting effects of the elements is significantly improved since for example during centrifugation or vortexing (shaking) the element is moved with a higher velocity through the mixing liquid.

Suitable materials with a sufficiently high specific density are known to the skilled person; only by way of example reference is made here to metallic materials or alloys. With the device in accordance with the present invention samples of any consistency may be collected quantitatively and in a reproducible manner and transferred into the mixing chamber filled with a liquid with the help of the ejection punch or piston.

Preferably the sampling rod or stick comprises a sample space designed in the form of or similar to a capillary. This allows the secure collection of samples with low viscosity, which are kept in the sample space through the capillary forces. In the case of stool samples it is thus possible to reliably collect soft to liquid stool as well as very rigid stool (often referred to as “concrete-like” stool). The device in accordance with the invention may, however, in the same way used for the collection and work up of food samples or living samples and biopsy samples. In addition, the device in accordance with the invention is also suitable for the storing and transport of living samples and cultures.

One segment of the sampling rod may consist of a reaction substance soluble in the liquid in the mixing chamber or may be coated therewith or represent a coated reaction particle. This allows to introduce an exactly dosed amount of a reaction substance or preserving substance during the mixing process into the liquid.

In the embodiment in which the element supporting the mixing process is transferred into the mixing chamber with the ejection punch or piston, the respective segment of said rod is preferably located between said element supporting the mixing process and the distal end of the ejection punch or piston.

In a further embodiment of the invention the ejection punch or piston comprises a conically expanding segment of the piston or punch in the direction of the proximal head end and a linear segment having a constant diameter of the punch or piston extending to the ejection end of the ejection punch or piston. The head end is guided in a first guiding channel of the sampling rod or stick. Both segments of the punch or piston are sealingly guided in a second guiding channel conically narrowing in the direction towards the sample space so that no liquid may leak to the outside through the hollow sampling rod or stick.

In accordance with a preferred embodiment the ejection punch or piston is equipped with means which prevents that the ejection punch or piston, once it has been inserted, could slide back or slide out in opposite direction to the direction of insertion. This can be achieved e.g. through the provision of a thread in the proximally located head-part of the ejection punch or piston, which is screwed in an interior counter thread in the sampling rod or stick. In lieu of a threaded cap or closure for screwing in, bayonet caps or closures or the like are also principally suitable which prevent the ejection punch or piston from sliding backwards. The length of the ejection punch or piston is selected in such a manner that the entire sample is ejected out of the sample space and the element supporting the mixing process is safely transferred into the mixing chamber in case of complete or full screwing-in if threaded caps or closures are used or in the case of closing the bayonet cap or closure.

Instead of thread-, screwing- or bayonet caps or closures simple embodiments are also conceivable, in which elements or means arranged in an obtuse angle relative to the main axis of the ejection punch or piston are provided which engage with complementary means of elements of the sampling rod or stick, thereby preventing a backward movement of the ejection punch or piston. By way of example scaled or imbricative elements may be mentioned, whose scale direction at the ejection punch or piston is opposite to the direction of the respective complementary scales in the interior hollow space of the sampling rod or stick. If an attempt is made to withdraw the ejection punch or piston, scale elements and complementary counter elements engage with each other and prevent the movement of the ejection punch or piston in a direction opposite to the direction of insertion.

The skilled person is aware of further alternatives for means effectively preventing a sliding-back or sliding-out of the ejection punch or piston once same has been inserted into the sampling rod or stick. He will, adopted to the specific situation, select the most suitable means or elements.

The means or elements for prevention of the sliding back of the ejection punch or piston furthermore have the positive side effect that a certain sealing effect is achieved which supports or improves the leak tightness of the sampling rod or stick against liquid flowing back and thereby prevent the leak-out of sample fluid during transport of the device.

The sampling rod or stick is preferably designed with a length that the sample space of the sampling rod or stick is fully immersed in the liquid in the mixing chamber after insertion of the sampling rod or stick with the sample into the sample tube (collecting tube). As a result thereof the sample during transport is always immersed in (surrounded by) liquid, which is necessary for some samples to obtain correct results of the measurements. The liquid in the mixing chamber can have a preserving effect on the sample and can thus prevent or at least retard their alteration under the influence of light, oxygen, viruses or bacteria.

In addition to the better preservation of the sample, designing the length of the sampling rod or stick has advantages during collection and taking of the sample, since, caused by the relatively large length of the sampling rod or stick a contact of the person taking the sample with the sample can be more safely be avoided, which is desirable in view of a potential falsification of measurement results as well as in view of a health endangerment of the person taking the sample by pathogens in the sample.

In a further embodiment of the invention the mixing chamber is limited on one side by an elastic sealing and wipe-off membrane with an opening therein through which the conically narrowing sampling rod or stick engages and on the other side with a dripping tip narrowing conically in the direction of its exit opening to obtain droplets of samples with constant volume for performing droplet tests.

The dripping tip can be connected through a thread or a similar design with the mixing chamber; preferably, however, the dripping tip is formed as one piece with the mixing chamber as this can provide advantages with regard to the leak tightness of the device in accordance with the invention during transport.

The exit opening of the dripping tip can be tightly sealed with a closure plug which is formed on the bottom of a closing cap which may be screwed together with the mixing chamber.

Alternatively, in accordance with another preferred embodiment of the present invention, the closing cap with the closure plug may form an integral part or element with the dripping tip. By removal of the closing cap by twisting off or a similar procedure the closing cap is simultaneously removed and the dripping tip can fulfil its function.

The device for the taking of samples thus satisfies the highest demands as far as leak tightness is concerned, e.g. during transport in airplanes. There is no risk of contamination in case of living samples, cultures or dangerous pathogens. Even after removal of the sampling rod or stick or after the removal of the closing cap with the closure plug the liquid will not leak out through the small opening in the sealing and wiping-off membrane or in the dripping tip. Only through manual pressure onto the elastic wall of the sample tube a droplet of the solution with always the same size is released through the conical dripping tip to the outside for examination in a diagnostic rapid test or into a tube. For further examinations a defined amount of the sample can be pipetted out of the mixing chamber or the device can be connected to an automatic analyzer.

In accordance with a further embodiment of the invention means for retaining solid particles in the liquid, i.e. insoluble components of the sample or particles, are provided in the dripping tip above the exit opening thereof or in the mixing chamber above the dripping tip. Such retention means may consist for example of a sieve or a grid with at least one transversal stop ridge. By virtue of this retention element the partial or entire blocking of the opening of the dripping tip is prevented. Thereby the production of sample droplets with constant volume for droplet tests can be achieved.

In the alternative embodiment of the present invention in which the device does not comprise a dripping tip at the end opposite to the distal end of the sampling rod or stick (often referred to as laboratory variant) said end opposite to the distal end may be designed spherically or conically. This prevents the deposition or retention (adhesion) of parts of the sample in the lower part of the device, which could detrimentally influence the results of the measurements.

In this embodiment, the device preferably can, after introduction of the sample to be analyzed into the mixing chamber be opened above the mixing chamber to allow the pipetting of a certain volume of the sample out of the mixing chamber or the part of the device which contains the sample to be analyzed may be directly introduced into an automatic analyzer or further used otherwise.

In principle it is also possible to convert a variant with a dripping tip into a laboratory variant by providing the dripping tip with a suitable closing cap or closing means which one hand allows the use in automated analyzers and on the other hand secures the required leak tightness. It is in principle also possible to permanently close the dripping tip of a device with dripping tip, i.e. to deprive the dripping tip of its original function and to use another closing cap or another design to give the end of the device opposite to the distal end of the sampling rod or stick the shape and form of the laboratory variant to achieve the usability in automatic analyzers. In accordance with another embodiment of the invention the ejection punch or piston may be designed, as far as its length is concerned, in such a manner that its end which does not serve the purpose of ejecting the sample, protrudes out of the sampling rod or stick and the sample can thus be transferred into the mixing chamber by pushing the ejection punch or piston. Alternatively, it is also possible to design the length of the ejection punch or piston in such a manner that the ejection punch or piston does not protrude out of the sampling rod or stick and the ejection punch, with the aid of an additional pushing-in means can transfer the sample into the mixing chamber.

It may also be advantageous, in particular if the device in accordance with the invention is inserted into automatic analyzers or colour changes are to be followed directly, to design the device such that same is transparent for the light used for analysis to thus allow visual following of a reaction or to make photometric measurements. Suitable materials in this regard are known to the person skilled in the art so that no further details are necessary here.

In the aforementioned embodiment of the present invention the device is preferably formed in two parts comprising the actual examination vessel which is preferably designed in its dimension in such a manner as to allow the direct use in respective laboratory automatic analyzers and which may be inserted in such analyzers and the second part in a leak tight but releasable manner with the first part, in which second part the sampling rod or stick is releasably positioned.

The second part of the device in accordance with the invention may be designed as tubular segment and may be connected to the first part serving as examination vessel through a plug and receptacle connector or a screwing connection. Preferably the part designed as examination vessel after separation respectively disconnection from the second part may be closed with a plug or a similar closing means in a leak tight manner.

To improve the leak tightness of the device circumferential elevations or ridges may be located in the connecting area of the second part which improve the sealing effect and at the same time ensure a safe connection of both parts of the device in accordance with the invention.

The device described above with two connectable parts is particularly suitable for the use in automatic analyzers since the transfer into a vessel suitable for use in the automatic laboratory analyzers can be dispensed of.

In accordance with a further preferred embodiment the outer boundary of the sampling space at the end of the sampling rod or stick preferably consisting of plastic material is limited by shovels (paddles, scoops) arranged with a distance between them. The sampling rod or stick can also be designed as narrow cannula, which may be in particular suitable for the take up of solid samples.

The person skilled in the art will select design and material of the sampling rod or stick in accordance with the respective testing method and the sample material and will thereby also define the amount of sample to be taken by a respective construction of the sampling space. In this way different sample amounts may be easily adjusted as generally used in respective tests. Only by way of example sample amounts of 4, 10, 20, 30 or 50 mg may be mentioned here.

To facilitate the filling of the mixing chamber with the liquid to be introduced into the mixing chamber the device in accordance with the invention is preferably designed in two parts, whereby both parts of the device may be connected with each other by plugging in or screwing in. It is important to assure that the leak tightness of the device during transport is guaranteed. Preferably the mixing chamber, eventually with the dripping tip connected therewith forms the first part of the device and the sampling rod or stick in a tubular container comprises the second part of the device. After filling of the mixing chamber with the liquid both parts are tightly formed together or connected with each other.

In the following the function of the device in accordance with the invention is described.

An embodiment of the invention is explained based on the figures, in which

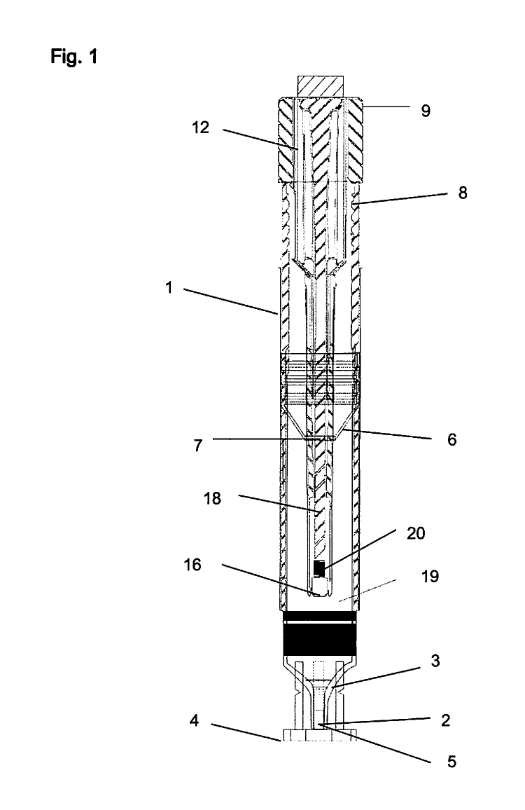

FIG. 1 is a side sectional view of a device for sampling or taking a sample,

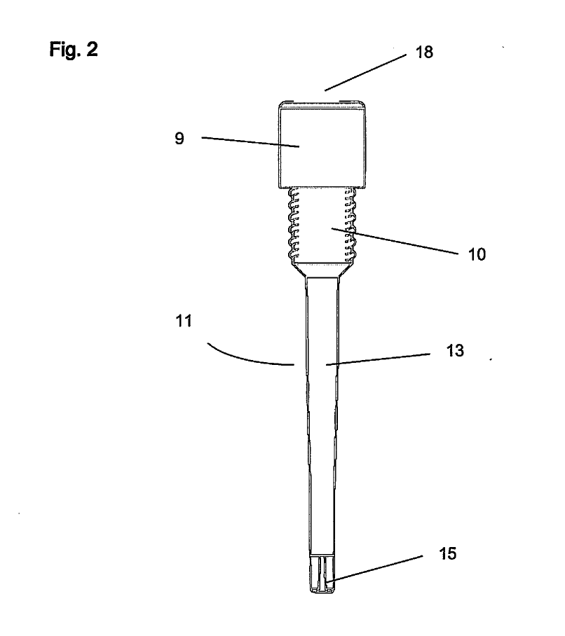

FIG. 2 is a side view of the sampling rod or stick,

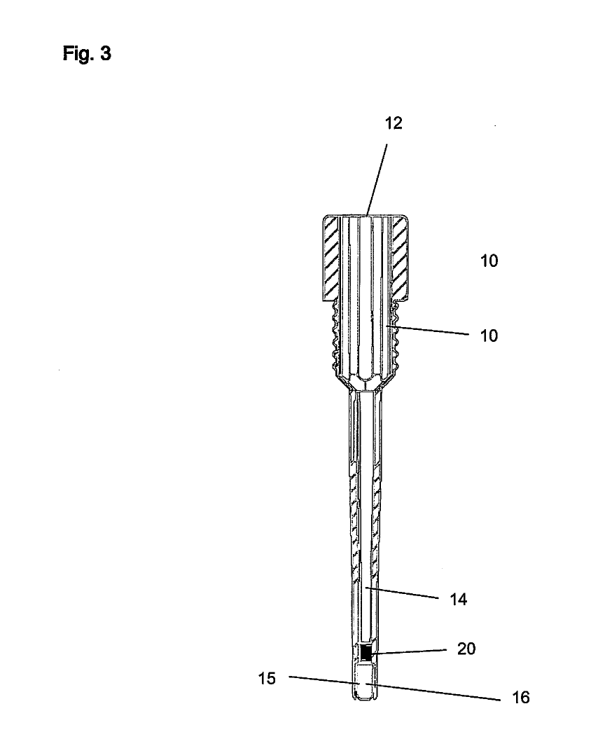

FIG. 3 is a sectional view of a sampling rod or stick without ejection punch or piston, and

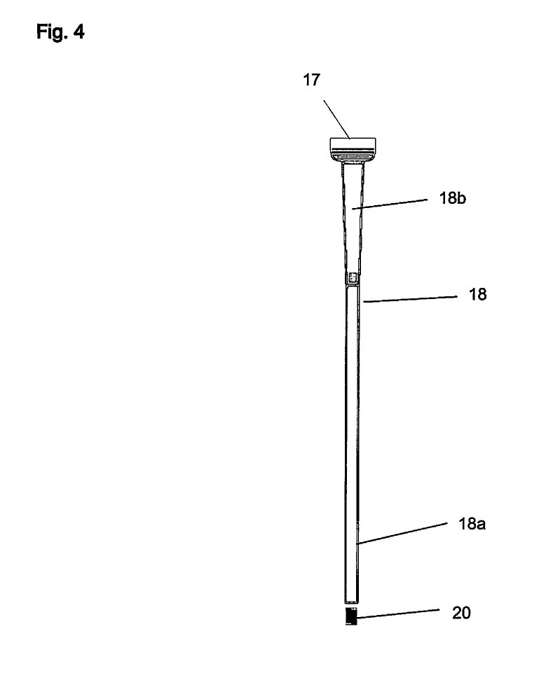

FIG. 4 shows a side view of the ejection punch or piston.

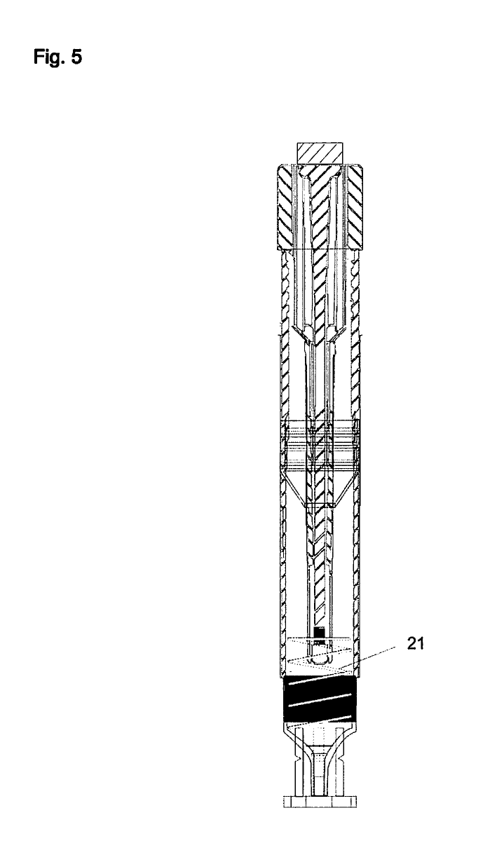

FIG. 5 shows a variant with an element supporting the mixing process already present in the mixing chamber.

The device shown in FIG. 1, which is designed for the taking and workup of stool samples, which may however also be used for the examination of food such as meat and sausage products, milk products or living samples and cultures and the like, comprises a sample receiving tube 1 with a dripping tip 3 which is inserted into the distal end of the sample receiving tube 1 and which comprises a defined exit opening 2.

A sieve or grid like retention element (not shown) located in the dripping tip 3 prevents the movement of solid particles into the area around the exit opening 2, which solid particles could otherwise negatively influence the droplet formation. The exit opening 2 is closed through a closing cap 4 screwed onto sample receiving tube 1 by virtue of a closure plug 5 integrally formed in the bottom of closing cap 4, which closure plug 5 engages entirely or partly with the exit opening 2. In the interior of the sample receiving tube 1 a sealing and wiping-off membrane 6 is arranged with a central opening 7, which one hand has a wiping-off function and on the other hand has a sealing function. At the proximal end of the sample receiving tube 1 an interior thread 8 is formed to allow fixation of a sampling rod or stick 11 provided with a grip part 9 and an exterior thread 10 vicinal or close to the grip part 9. The sampling rod or stick 11 protrudes in its lower area through the opening 7 of the membrane 6 into the mixing chamber 19 or sample receiving tube 1 located below membrane 6. This mixing chamber is closed in leak tight manner by membrane 6 on one side and on the opposite side by closing cap 4 with closure plug 5.

The sampling rod or stick 11, designed as a hollow body, comprises in the area of grip part 9 and exterior thread 10 a first wide guiding channel 12. Below the exterior thread 10 a conically narrowing tubular pipe segment 13 with significantly narrower outer diameter and a second narrow, conically narrowing guiding channel follow. The rod segment 13 ends in shovels 15 extending from the free front end of the rod segment 13, which enclose a longitudinally extending sample space 16 functioning as a capillary. The size of the sample space 16 may be different, depending on the type of sample material and the type of test procedure used or the type of testing equipment used, to enable the taking of different amounts of samples.

In the interior of sampling rod or stick 11 an ejection punch or piston 18 is arranged, which ejection punch or piston 18 has a head part 17 closing the open end of the sampling rod or stick 11. Below the free front face of the sampling rod or stick element 20 is arranged which may be transferred from the sample space 16 into the mixing chamber 19 during the ejection of the sample from sample space 16 into mixing chamber 19.

Through the length of the first-wide-guiding channel 12 the head part 17 of the ejection punch or piston 18 may be adjusted in its position and thus the distal end, i.e. the end located next to sample space 16, of sampling rod 11 may be moved far down into the mixing chamber.

In FIG. 5 a device in accordance with the invention is shown, the construction of which is similar to that of FIG. 1 to a major extent. However, in this embodiment an element 21 supporting the mixing process is already contained in the mixing chamber. Instead of a closed dripping tip as shown in FIG. 5, the lower part may be preferably oval or have a circular shape. This prevents the settling and adhesion of samples in the edges and corners which is often to be seen in devices in which this area comprises edges.

In the following the function of the device described above for the taking and workup of a sample is described.

The mixing chamber 19 of the ready for use device shown in FIG. 1 is filled with a solution, e.g. a buffer solution comprising antioxidants. For taking of a sample the sampling rod 11 is screwed out of sample receiving tube 1 and the tip of the sampling rod 11 is completely immersed into the sample material, turned around and is subsequently removed again out of the sample material. The sample space is now entirely filled with the sample taken in accordance with the size of the sample space 16 enclosed by shovels 15 with a determined amount of material suitable for the subsequent analysis.

Through the design of the sample space as narrow capillary it is assured, that very soft or even liquid samples are securely hold in the sample space through the capillary effect and fill said space entirely. During taking the sample, i.e. during the time in which the sampling rod 11 is not inserted into opening 7 of membrane 6 no liquid may leak out of the mixing chamber 19 if the sample receiving tube 1 is accidentally turned over because no liquid can leak out through the very small opening 7 or membrane 6 due to the surface tension.

After taking the sample the sampling rod 11 is inserted again into the sample receiving tube 1. In this step the front segment of sampling rod 11 is guided through opening 7 in membrane 6. The rim of opening 7, the diameter of which is smaller than the outer diameter of sampling rod 11 at the distal end thereof, is elastically pressed to the outer circumference of sampling rod 11 so that parts of the sample adhering to the outer surface of the sampling rod are wiped off and, in connection with the sealing thread (8, 10) of sampling rod 11 in sample receiving tube 1 a secure sealing at the proximal end of the device is guaranteed. The sealing between the mixing chamber 19 and the conically narrowing second guiding channel 14 is secured through the elastic effect of guiding channel 14 on ejection punch 18. In the device shown, the sealing effect is further improved by the fact that a lower segment 18a of ejection punch 18 is followed by a conically expanding segment 18b. The safe tightening at the distal end is achieved through closing cap 4 with closure plug 5.

To achieve dissolution of the entire amount of sample the ejection punch 18 is pushed downwards so that the sample is immersed in the liquid in mixing chamber 19 and can dissolve easily. Element 20 is transferred thereby into the mixing chamber and serves during subsequent shaking or centrifuging to improve the dissolution as means to improve the mixing on one hand and to improve the entire dissolution of the sample in the liquid on the other hand. Between the free end of ejection punch 18 and element 20 a rod segment may be located which either consists entirely of a reaction substance which dissolves in the liquid after ejection or which is coated with such a substance.

With the device in accordance with the invention repeated quantitative droplet tests may be performed due to the constant size of dripping tip 3 which provides a constant droplet size. Pipetting tests and automated tests may also be performed. The device is suitable for the taking and workup of liquid as well as rigid samples and thus equally suitable for stool samples as well as for food samples, living samples and cultures.

In the embodiment described above the sample taking device is made of plastic material. For the taking of very rigid samples the sampling rod with the sample space may also be formed as metallic cannule.

### LIST OF REFERENCE NUMERALS

1 Sample receiving tube
2 Exit opening of 3
3 Dripping tip of 1
4 Closing cap
5 Closure plug of 4
6 Sealing and wipe-off membrane
7 Opening of 6
8 Interior thread of 1
9 Grip part of 11
10 Exterior thread of 11
11 Sampling rod or stick
12 first guiding channel of 11
13 conical rod segment of 11
14 second guiding channel of 11
15 Shovels of 16
16 Sample space, capillary space of 11
17 head part of 18
18 ejection punch or piston
18a straight lower part of 18
18b conically expanding upper part of 18
19 mixing chamber of 1
20 element supporting the mixing
21 element supporting the mixing

1. Device for taking, work-up and preliminary analysis of a sample, comprising a sampling rod with a sample taking structure forming a sample space for taking a defined amount of a sample and a sample receiving tube, comprising a mixing chamber filled with liquid for preserving, dissolution, workup and development of the sample contained in sample space, wherein the sampling rod is designed as hollow body open on both sides with an ejection punch movably and sealingly guided in the sampling rod designed to eject the sample from sample space into mixing chamber, wherein
a) in the interior part of the sampling rod an element for supporting the mixing process is provided which is transferred into mixing chamber in the course of ejection of the sample with ejection punch and which consists of a material having a specific density of at least 2 g/cm³ and/or
b) an element supporting the mixing process and freely movably in the mixing chamber is provided in the mixing chamber which consists of a material having a specific density of at least 2 g/cm³.

2. Device in accordance with claim 1 wherein the element supporting the mixing process is provided in the interior of the sampling rod.

3. Device in accordance with claim 1 wherein the element supporting the mixing process is provided in the mixing chamber.

4. Device in accordance with claim 1 wherein the element consists of a metallic material with a smooth surface.

5. Device in accordance with claim 1 wherein element has the form of a spiral or is formed spiral-like.

6. Device in accordance with claim 1 wherein the ejection punch comprises a punch section conically expanding in the direction towards a proximally formed head part and a straight section with constant diameter, wherein the head part is sealingly guided in a first guiding channel of sampling rod and the punch segments are sealingly guided in a second guide channel conically narrowing in the direction towards the sample space.

7. Device in accordance with claim 1 wherein the mixing chamber is limited on one side by an elastic membrane with an opening into which the sampling rod sealingly engages and is limited on the other side by a dripping tip narrowing in direction towards its exit opening to produce sample droplets with constant volume and wherein the dripping tip comprises an integrally formed closing cap with a closure plug.

8. Device in accordance with claim 1 wherein the ejection punch is equipped with means preventing a sliding back or moving out of ejection punch after insertion into sampling rod.

9. Device in according with claim 1 wherein the sample receiving tube is formed in two parts.

10. Device in accordance with claim 7 wherein the sample receiving tube consists of an examination vessel, which is preferably designed in its dimensions as to allow direct insertion into automatic laboratory analyzers and which can be inserted into same and a second part, connected to the first part in a leak tight but releasable manner.
